(19) United States
(12) Patent Application Publication
(10) Pub. No.: US 2024/0375250 A1
(43) Pub. Date: Nov. 14, 2024

(54) TOOL FOR MANIPULATING A GRATING PANEL

(71) Applicant: THE HAND SAFETY TOOL COMPANY, LLC, MISSOURI CITY, TX (US)

(72) Inventor: CHRISTOPHER RYAN LEE, MISSOURI CITY, TX (US)

(21) Appl. No.: 18/655,469

(22) Filed: May 6, 2024

Related U.S. Application Data
(60) Provisional application No. 63/464,786, filed on May 8, 2023.

(51) Int. Cl. B25B 9/00

(52) U.S. Cl. CPC B25B 9/00

(57) ABSTRACT

A tool includes an elongate shaft having a proximal end and a distal end, a handle disposed on the proximal end of the elongate shaft, a hook secured to the distal end of the elongate shaft, a housing slidably secured around the elongate shaft between the proximal and distal ends of the shaft, and a clutch-lock mechanism integrated into the housing and including a manually actuatable trigger. The clutch-lock mechanism passively grips the elongate shaft to prevent the housing from sliding toward the proximal end of the elongate shaft. However, manual actuation of the trigger releases the clutch-lock mechanism to allow the housing to slide toward the proximal end of the elongate shaft. The tool may be used to manipulate a grating panel.

### BACKGROUND

The present disclosure relates to a tool for handling a grating panel.

### BACKGROUND OF THE RELATED ART

A grating or grating panel is a mechanical structure having a primary set of regularly spaced elongated elements or bars. The elongated elements may be secured together with a secondary set of elongated elements, which are often perpendicular to the primary set. The size, strength and material of grating may vary widely in accordance with the purpose of the grating. For example, a grating that covers an outdoor drain located in a street or sideway may be made of iron bars having a spacing that allows the passage of water through the drain, but blocks and supports large objects. A grating may also be provided in panels that are used to form decks on footbridges and catwalks. Depending upon the specific environment and application, grating may be made with an aluminum alloy, steel, fiberglass or other metals or composites.

Gratings can be difficult to handle for various reasons. First, a grating may extend over a large area and may be heavy due to its material of construction. The size and weight of the grating may be a function of how the grating is intended to be used. Second, a grating may be difficult to grasp or grip since the primary function of the grating may require the accessible area of the grating to be relatively flat. For example, most gratings are not provided with handles because a handle feature would interfere with walking or driving over the grating. Third, a grating may be slippery as a result of the conditions in which the grating is being used.

### BRIEF SUMMARY

Some embodiments provide a tool comprising an elongate shaft having a proximal end and a distal end, a handle disposed on the proximal end of the elongate shaft, a hook secured to the distal end of the elongate shaft, a housing slidably secured around the elongate shaft between the proximal and distal ends of the shaft, and a clutch-lock mechanism integrated into the housing and including a manually actuatable trigger. The clutch-lock mechanism passively grips the elongate shaft to prevent the housing from sliding toward the proximal end of the elongate shaft. However, manual actuation of the trigger releases the clutch-lock mechanism to allow the housing to slide toward the proximal end of the elongate shaft.

### BRIEF DESCRIPTION OF THE SEVERAL VIEWS OF THE DRAWINGS

FIG. 1 is a perspective view of a tool for manipulating a grating panel according to one embodiment.

FIG. 2 is a perspective view of a grating panel.

FIGS. 3A-E are a series of side views of the tool illustrating steps used to secure a grating panel for manipulation using the tool.

FIG. 4A is a cross-section side view of the housing disposed about the elongate shaft with the clutch-lock mechanism in a passive condition gripping the elongate shaft.

FIG. 4B is a cross-section side view of the housing disposed about the elongate shaft with the trigger actuated to cause the clutch-lock mechanism to release the grip on the elongate shaft.

FIG. 5 is a diagram of a locking ring having an interior cutout that encircles the elongate shaft.

FIGS. 6A-B are diagrams of the locking rings of FIGS. 4A-B that have been enlarged to better illustrate the edges of the interior cutout in the locking rings gripping the elongate shaft (FIG. 6A) and releasing the elongate shaft (FIG. 6B).

FIG. 7 is an exploded assembly view of the housing and the clutch-lock mechanism in reference to the elongate shaft.

FIGS. 8A-C are perspective views of a hook aligned to be secured to a distal end of the elongate shaft, the hook after being secured, and a second hook secured in the same manner.

### DETAILED DESCRIPTION

Some embodiments provide a tool comprising an elongate shaft having a proximal end and a distal end, a handle disposed on the proximal end of the elongate shaft, a hook secured to the distal end of the elongate shaft, a housing slidably secured around the elongate shaft between the proximal and distal ends of the shaft, and a clutch-lock mechanism integrated into the housing and including a manually actuatable trigger. The clutch-lock mechanism passively grips the elongate shaft to prevent the housing from sliding toward the proximal end of the elongate shaft. However, manual actuation of the trigger releases the clutch-lock mechanism to allow the housing to slide toward the proximal end of the elongate shaft.

The tool may be used to manipulate a grating panel, but the use of the tool is not so limited. In fact, the tool could be used to manipulate any object having a T-slot or similar slot, channel or opening. One benefit of the tool is that a grating panel or other object may be manipulated safely without a person having to touch or grab the grating panel. Accordingly, the tool improves hand safety.

The elongate shaft is preferably cylindrical, such as a solid cylinder or a hollow tube. However, the outer surface of the elongate shaft may be machined to provide a uniform diameter along any portion of the elongate shaft where the housing is intended to be used. Although the total length of the elongate shaft is not limited, the elongate shaft has a preferred total length between 2 and 4 feet.

The hook may be a single hook or a double hook. A single hook has one lateral arm with an upturned end, whereas a double hook has two lateral arms that each have an upturned end. A preferred double hook may be referred to as a T-shaped double hook, since the two lateral arms extend in opposite directions from the point of connection with the elongate shaft. In one option, the hook may be fabricated from steel, such as a steel plate having a nominal or actual thickness of about ⅛ inch (about 0.125 inch). In another option, the hook may be fabricated with 1045 steel or another steel alloy that is stronger than 1045 steel.

The housing includes surfaces that engage the elongate shaft to slidably secure the housing around the elongate shaft. The surfaces that engage the elongate shaft may include one or more sleeve bearings. The housing further provides support for the operation of the clutch-lock mechanism. The housing preferably encloses the clutch-lock mechanism to protect the mechanism from dirt and damage, leaving only the manually actuatable trigger to be accessed by a person utilizing the tool.

The clutch-lock mechanism is a complex machine that converts the motion of actuating the trigger into a motion to release a passive grip on the elongate shaft. The trigger is preferably positioned to be actuated by a hand gripping the housing so that one hand may be used to both actuate the trigger and slide the housing without repositioning the hand.

In some embodiments, the distal end of the housing secures an end cap. The end cap may be positioned to contact and secure an object, so it should be made with a durable material. The end cap is preferably made with metal, such as steel, aluminum, or other materials having comparable or greater hardness. While an aluminum end cap may experience marring or other minor damage, such minor wear is unlikely to have any negative affect on the overall functionality of the tool. Accordingly, aluminum may be preferred in some embodiments because it weighs less than many other metals. As used herein, the term “aluminum” includes both aluminum and aluminum alloys in which aluminum is the predominant metal. Optionally, the housing may be made with a rigid plastic, such as high-density polyethylene (HDPE), although the end cap is made with metal. The end cap may be formed in the shape of a ring around the elongate shaft, and preferably extends radially at least as far as a radial dimension of the lateral arm of the hook.

In some embodiments, the hook and the distal end cap of the housing may be configured to secure a grating element of a grating panel therebetween. One non-limiting example of a grating panel includes bearing bars that have a substantially uniform spacing and extend over a span of the grating panel, as well as cross bars that connected to the bearing bars to maintain the spacing and/or orientation of the bearing bars. The bearing bars may be load-bearing members having a consistent set of dimensions, such as such a thickness and depth for a rectangular bearing bar. The hook should have a width that will fit through the spacing between adjacent bearing bars of the grating panel yet retains enough strength to support the grating panel. The hook should also have a sufficient lateral arm dimension to extend under a bearing bar or other grating element. The hook preferably also has an upturned end that extends some fraction of the depth of the bearing bar. In one option, the hook may be a double hook, such as a T-shaped double hook. Such a double hook has two lateral arms, where each lateral arm preferably has an upturned end. The upturned ends are preferably spaced apart by a distance sufficient to extend around opposing sides of two adjacent grating elements. For example, a T-shaped double hook will have a first lateral arm that extends in a first radial direction from the elongate shaft and a second lateral arm that extends in a second radial direction from the elongate shaft, where the first and second radial directions are generally opposite directions.

In some embodiments, a grating element may be secured with the elongate shaft extending along a first side of the grating element, the hook extending under the grating element and along a second side of the grating element, and the distal end cap of the housing positioned against a top of the grating element. In such a configuration, the grating element is secured by a structural element of the tool in all four directions, namely top, bottom, first side and second side. This manner of securing the grating element assures that the grating panel will not separate from the tool during manipulation of the grating panel. Furthermore, the grating element may remain secured between the distal end cap, the elongate shaft and the hook until the trigger is manually actuated to release the clutch-lock mechanism and the housing is slid toward the proximal end of the elongate shaft.

In some embodiments, the clutch-lock mechanism includes a cam that is pivotally secured within the housing, a locking ring set encircling the elongate shaft and a compression spring. A first portion of the cam engages an inside surface of the trigger, and a second portion of the cam engages a distal face of the locking ring set on a first side of the elongate shaft. The compression spring engages a proximal face of the locking ring set to bias the locking ring set in a distal direction. However, the housing may form a distal stop element that limits distal movement of the locking ring set on a second side of the elongate shaft. Therefore, with the trigger released (i.e., not actuated), the spring is able to push the top side of the locking ring set further along the shaft (in the distal direction) than the lower side of the locking ring set, such that the locking ring set becomes tilted relative to an axis of the elongate shaft (i.e., the locking ring set is not perpendicular to the elongate shaft) to grip the elongate shaft.

In some embodiments, the housing forms a proximal stop element that limits proximal movement of the locking ring set on the first side of the elongate shaft and a distal stop element that limits distal movement of the locking ring set on the second side of the elongate shaft. The first and second sides of the elongate shaft are generally opposite sides about a circumference of the elongate shaft. The positioning of the proximal and distal stop elements may be used to stop the rotation of the locking ring set in a predetermined position where the locking ring set or the individual rings of the locking ring set will be perpendicular to the central axis of the elongate shaft (i.e., the central axis of the cutout in the locking ring set will be parallel to the central axis of the elongate shaft). Without either stop element, actuation of the trigger might cause the locking ring set to initially be released due to a certain amount of rotation, but then might rotate further to grip the elongate shaft due to tilting in the other direction unless the user carefully controlled an extent of trigger actuation. The stop elements allow a user to firmly actuate the trigger, which rotates the cam to cause the second portion of the cam to push against the distal face of the locking ring set on the first side of the elongate shaft, such that the first side of the locking ring set is firmly pressed against the proximal stop element and the locking ring set is positioned to release the grip on the elongate shaft. Specifically, when the distal face of the locking ring set is in contact with the distal stop element on the second side of the elongate shaft and the proximal face of the locking ring set is in contact with the proximal stop element on the first side of the elongate shaft, the locking ring set is substantially perpendicular to an axis of the elongate shaft. When the locking ring set is substantially perpendicular to the axis of the elongate shaft, the locking ring set does not grip the elongate shaft and a user is then able to freely slide the housing along the length of the elongate shaft in a proximal direction and/or a distal direction.

In some embodiments, the locking ring set has any number of one or more individual locking rings. The locking ring set preferably has three or more rings, since an increase in the number or rings provides an increase in the number of sharp edges engaging the shaft and causing an increased gripping of the shaft (i.e., an increase in the amount of an axially directed force that the clutch-lock mechanism can resist). A most preferred embodiment has three rings in the locking ring set. The individual rings of the locking ring set have an interior cutout with sharp edges. The sharp edges are finely squared-off corners of the interior cutout. It is these sharp edges of the interior cutout that grip the shaft. Furthermore, there is a range of tolerance between the outer diameter of the shaft and the shape and size of the interior cutout of the rings. The diameter of the shaft should be small enough relative to the interior cutout of the rings so that the shaft may pass through the rings cleanly without binding when the trigger is actuated (i.e., the rings are substantially perpendicular to the shaft). However, the diameter of the shaft should not be so small relative to the interior cutout of the rings that the rings are unable to engage and lock onto the shaft at all. The individual locking rings may be generally flat steel plates, such that multiple locking rings may be positioned in face-to-face contact to establish a locking ring set. In one option, the individual locking rings may have a pair of laterally extending tabs disposed on the second side of the elongate shaft that fit into corresponding grooves or channels formed on opposing sides of the housing. For example, each of the rings in the locking ring set may have a pair of outward extending tabs, the housing may include a pair of grooves, and each groove may receive one of the tabs to limit movement of the tab. The distal ends of the grooves may form the distal stop element. In a further option, the individual locking rings may have a cam follower tab disposed on the first side of the elongate shaft aligned between the second portion of the cam and the proximal stop element. When the trigger is actuated, the second portion of the cam will then press against the cam follower tab. If there are multiple locking rings in the locking ring set, actuating the trigger will press the cam against the locking ring in the most distal position and the locking ring in the most proximal position will be pressed against the proximal stop element.

In some embodiments, the specific direction of the tilt of the locking rings binds or grips the elongate shaft and “locks” the housing against sliding movement in a specific direction along the elongate shaft. It may be possible to slide the housing with the clutch-lock mechanism in the distal direction along the shaft without actuating the trigger. However, without actuating the trigger, there can be significant friction resisting the sliding movement of the housing in the distal direction along the shaft. A preferred operation is to actuate the trigger for sliding the housing along the shaft regardless of whether the housing is to be slid in the distal direction or the proximal direction. However, the clutch-mechanism is preferably designed to prevent the housing from sliding in the proximal direction (i.e., away from the distal end of the shaft) unless the trigger has been manually actuated.

In some embodiments, the housing may be able to move in the distal direction, even with the trigger released, because friction between the shaft and the rings in that direction will simply push the rings against the spring to relieve the friction and allow the housing to move. By contrast, the housing cannot move in the proximal direction with the trigger released, because the friction between the shaft and the rings in that direction will further bias the rings against the shaft and grip the shaft even tighter since the lower side of the rings cannot move in that direction (due to the distal stop element) while the upper side of the rings is free to move in that direction (both the spring and the friction are biasing the upper side of the rings in the same direction).

In some embodiments, the elongate shaft and the locking rings may be made of steel. However, the locking rings are preferably made with a steel alloy that is harder than the steel alloy used to make the elongate shaft. This allows the edges of the interior cutout in the locking rings to better grip the surface of the elongate shaft. In one specific option, the elongate shaft may be A36 mild steel, and the locking rings may be 1045 carbon steel (which is harder than A36 mild steel).

In some embodiments, the handle may be a D-handle. The D-handle has one end that is securable to the elongate shaft and a second end forming a hand grip that is transverse to the axis of the elongate shaft. For example, the first end may have an opening that fits uniformly about the proximal end of the elongate shaft and may be secured to the elongate shaft with a fastener, such as a screw, bolt or pin extending therethrough. The D-handle may have two side braces that diverge apart and secure the hand grip therebetween.

In some embodiments, the hook is detachably secured to the distal end of the elongate shaft with a threaded screw. The detachability of the hook facilitates replacement of a damaged hook and/or substitution of the hook for a hook having a different size, shape or configuration better suited for manipulating a particular object, such as a grating panel. In particular, the hook may be substituted based upon the grating element dimensions and spacings. In one option, the distal end of the elongate shaft may have an axial protrusion that is not circular, and the hook may have an opening with a complementary shape that fits around the protrusion and prevents rotation of the hook relative to the elongate shaft. The hook may be secured with the opening positioned around the protrusion using a threaded fastener, such as a bolt. Optionally, the threaded fastener may include a flange or may be used in combination with a washer.

In some embodiments, the housing may include one or more sleeve bearings. Any sleeve bearing may be made with a material known for having a low coefficient of friction, such as a self-lubricating plastic. Non-limiting examples of a self-lubricating plastic include polyoxymethylene (POM), polyamides (PA), polymethylmethacrylate (PMMA), and polyetheretherketone (PEEK). Furthermore, a suitable sleeve bearing may be made with one or more bearing elements disposed about the circumference of the shaft. For example, a first bearing element may be disposed on one side of the elongate shaft and a second bearing element may be disposed on an opposite side of the elongate shaft. The housing preferably has multiple sleeve bearings, such as a first sleeve bearing at a proximal end of the housing, a second sleeve bearing at a distal end of the housing, and a third sleeve bearing in a central region of the housing.

In some embodiments, the housing may be a housing assembly formed by two housing halves or sides that are secured together around the elongate shaft and hold the components of the clutch-lock mechanism in place. The housing halves may be secured together with screws or bolts. Furthermore, the housing may include an end cap at the distal end of the housing and a front cap at the proximal end of the housing. Optionally, the end cap and the front cap may fully encircle the elongate shaft without being formed by two halves. For example, after securing the two housing halves together, the front cap may be secured to the proximal end of the housing with screws or bolts. Either or both of the end cap and front cap may include a sleeve bearing or form a bearing surface.

Some embodiments provide a kit that includes the apparatus or tool, as well as one or more additional hooks having a unique size, shape or configuration. For example, a kit might include one double hook and one single hook. The double hook might be used to handle a first type, size or configuration of grating panel and the single hook may be used to handle a second type, size or configuration of grating panel. Some grating panels may be made with thin metal bars and other grating panels may be made with square fiberglass elements. A hook may be specifically made for a particular type, size and configuration of grating panel. Specifically, hooks may vary in any one or more dimension, such as the length of a lateral portion of the hook for extending perpendicular to the shaft under a grating element and/or the length of an upturned portion of the hook for extending along a side of a grating element.

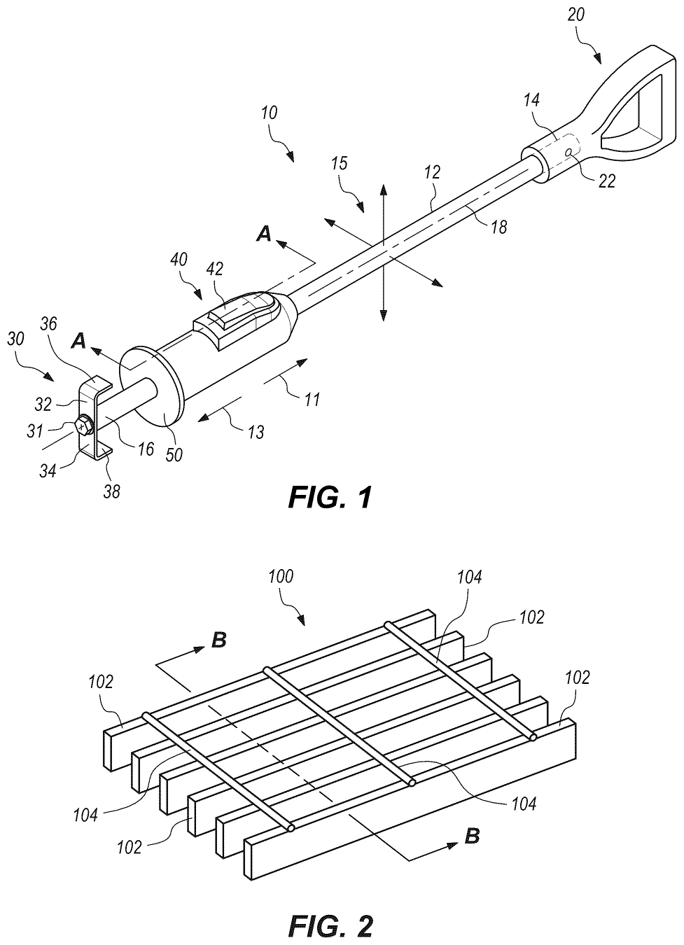

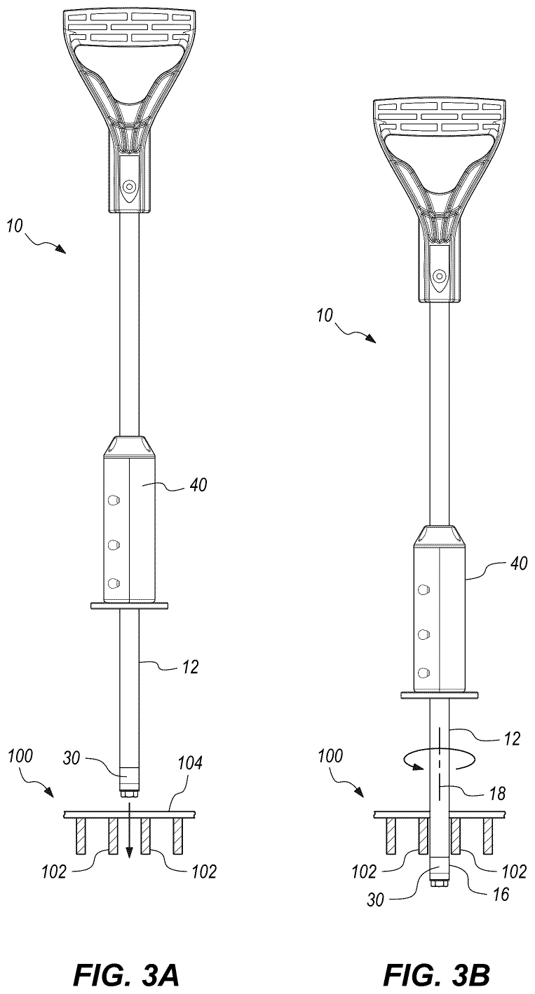

FIG. 1 is a perspective view of a tool 10 for manipulating a grating panel (see FIG. 2) according to one embodiment. The tool 10 includes an elongate shaft 12 having a proximal end 14 and a distal end 16. A handle 20 is secured to the proximal end 14 of the elongate shaft 12 using a fastener 22, such as a threaded screw, bolt or pin. A hook 30 is secured to the distal end 16 of the elongate shaft 12, using another fastener 31. The hook 30 is illustrated as a double hook (T-hook) having a first lateral arm 32, a second lateral arm 34, a first upturned end 36 and a second upturned end 38.

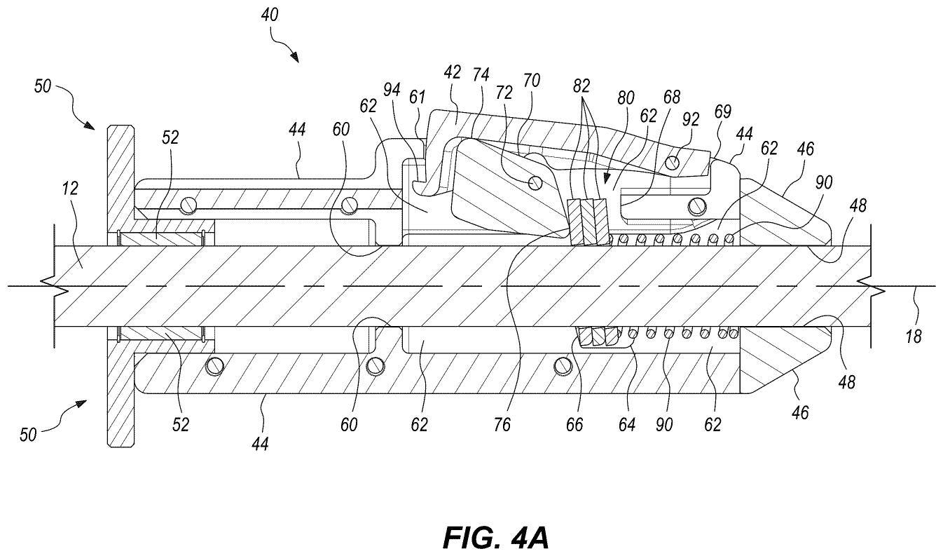

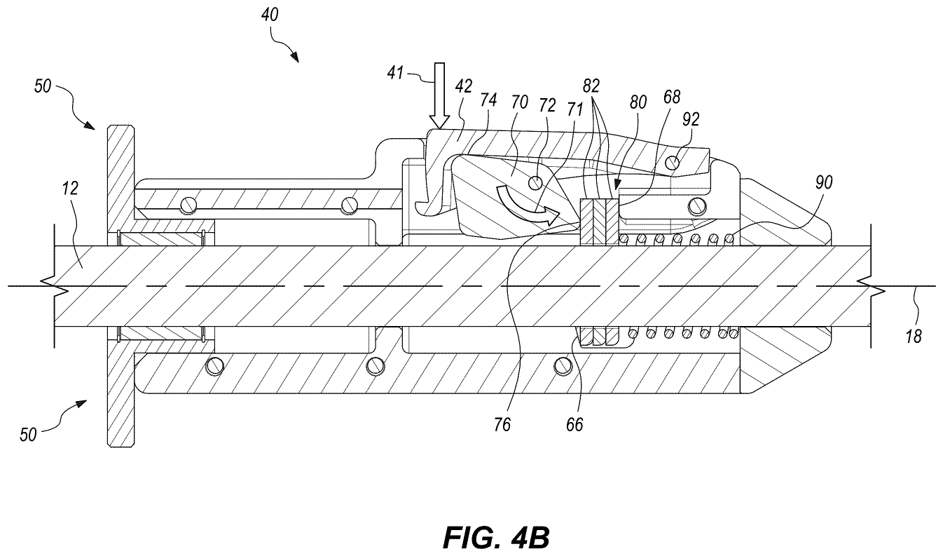

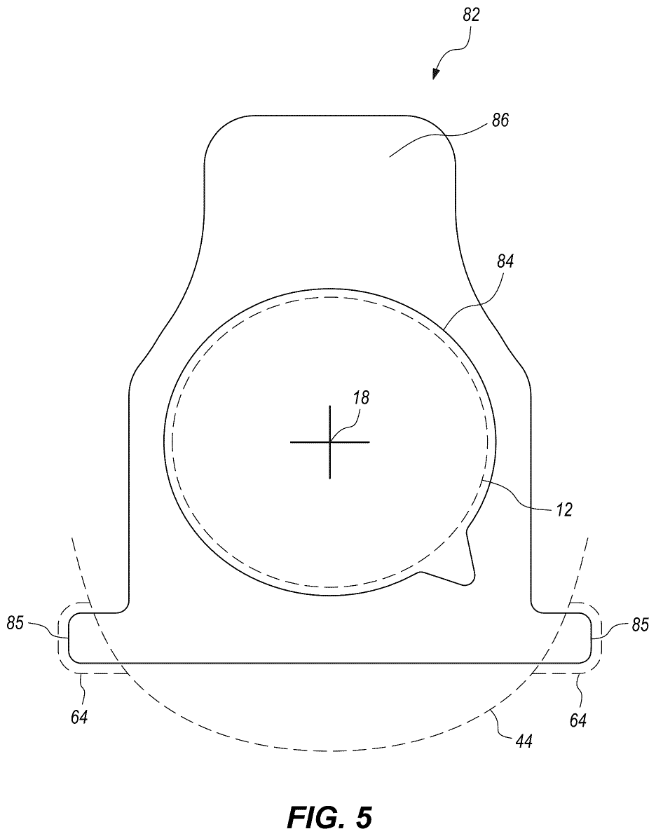

A housing 40 is slidably secured around the elongate shaft 12 between the proximal end 14 and distal end 16 of the shaft 12. A clutch-lock mechanism (not shown; see FIGS. 4A, 4B and 5) is integrated into the housing 40 and includes a manually actuatable trigger 42. The clutch-lock mechanism passively grips the elongate shaft 12 to prevent the housing 40 from sliding toward the proximal end 14 of the elongate shaft 12. However, manual actuation (pressing) of the trigger 42 releases the clutch-lock mechanism to allow the housing 40 to slide toward the proximal end 14 of the elongate shaft 12. The trigger 42 is preferably also manually actuated (pressed) when sliding the housing 40 toward the distal end 16 of the elongate shaft 12. An end cap 50 is also shown secured to the distal end of the housing 40.

The terms “proximal” (meaning “close to” or “nearest”) and “distal” (meaning “away from” or “furthest”; generally, the opposite of “proximal”) are used to describe the orientation and placement of certain components or the direction of movements. For the purposes of the present description of the tool, the terms “proximal” and “distal” are used in reference to a hypothetical user that would grab the tool from the handle 20. While the user may also grab the housing 40, the present description has been prepared using the convention that the end of the tool having the handle is the “proximal” end and the end of the tool having the hook 30 is the distal end (i.e., the opposite end from the proximal end).

Furthermore, the elongate shaft 12 has a central axis 18. Accordingly, the sliding movement of the housing 40 along the elongate shaft 12 may be referred to as “axial” movement, and the “axial” movement may be either axial movement in the “proximal direction” (see arrow 11; movement toward the proximal end 14) or axial movement in the “distal direction” (scc arrow 13; movement toward the distal end 16). In addition, the term “lateral” may be used to refer to a placement or movement that is directed away from the central axis 18 (for example, see arrows 15 that illustrate non-limiting examples of a “lateral” direction).

FIG. 2 is a perspective view of a grating panel 100. Grating is a mechanical structure having a primary set of regularly spaced elongated elements or bars 102. The elongated elements 102 may be secured together with a secondary set of elongated elements, such as cross bars 104, which are often perpendicular to the primary set. The size, strength and material of grating may vary widely in accordance with the purpose of the grating. For example, a grating that covers an outdoor drain located in a street or sideway may be made of iron bars having a spacing that allows the passage of water through the drain, but blocks and supports large objects. A grating may also be provided in individual panels that are used to form decks on footbridges and catwalks. Depending upon the specific environment and application, grating may be made with an aluminum alloy, steel, fiberglass or other metals or composites.

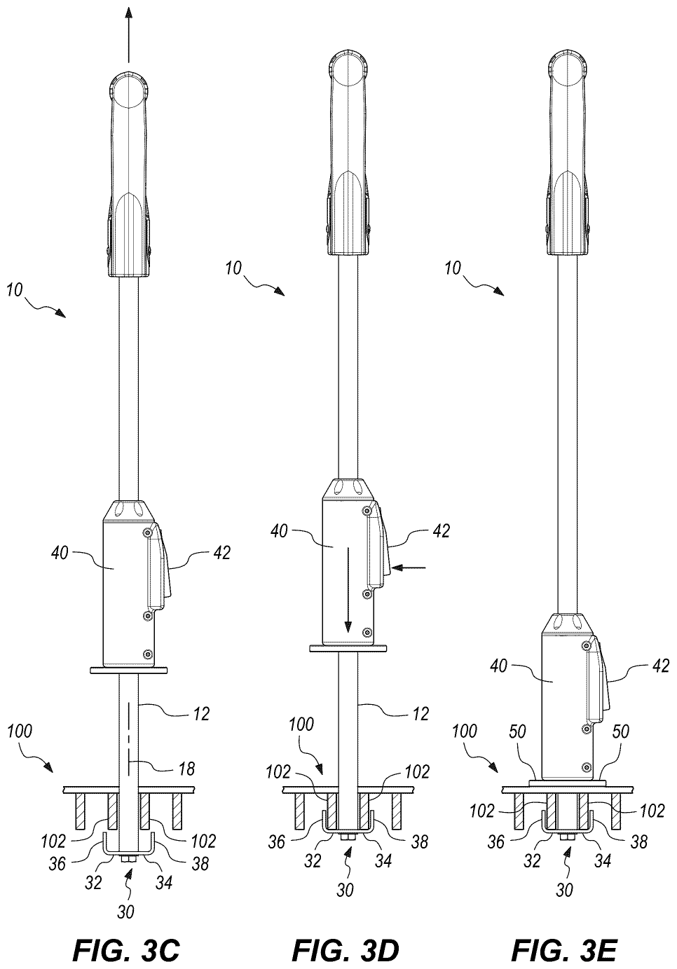

FIGS. 3A-E are a series of side views of the tool illustrating steps used to secure a grating panel (viewed from line B-B in FIG. 2) for manipulation using the tool. In FIG. 3A, the tool 10 is positioned over the grating panel 100 with the double hook 30 turned with its lateral arms 32 (not shown) turned to extend parallel to the grating elements 102 so that the hook may pass between two adjacent grating elements 102. In FIG. 3B, the tool 10 has been lowered such that the distal end 16 of the elongate shaft 12 is positioned between the two adjacent grating elements 102 with the double hook 30 now lower than the bottom of the grating panel 100. In FIG. 3C, the tool 10 has been rotated a quarter-turn (90 degrees) about the central axis 18 of the elongate shaft 12. Therefore, the lateral arms 32, 34 of the double hook 30 now extend under the two adjacent grating elements 102.

In FIG. 3D, the tool 10 is lifted a short distance until the double hook 30 engages the underneath side of the two adjacent grating elements 102. Specifically, the first lateral arm 32 extends under a first grating element 102 and its upturned end 36 extends along the side of the first grating element 102 (i.e., the side facing away from the elongate shaft 12; to the left in FIG. 3D). Similarly, the second lateral arm 34 extends under a second grating element 102 (on the opposite side of the elongate shaft 12 from first grating element 102) and its upturned end 38 extends along the side of the second grating element 102 (i.e., the side facing away from the elongate shaft 12; to the right in FIG. 3D). In this position, the trigger 42 is manually actuated (pressed) to release the housing 40 from its grip on the elongate shaft 12 and allow the housing to slide downward (in the distal direction) toward the top surface of the grating panel 100.

In FIG. 3E, the housing 40 has been slid downward along the elongate shaft 12 until the end cap 50 is pressed against the top surface of the grating panel 100. In this position of the tool 10 with the hook 30 disposed under and beside the grating elements 102 and this position of the housing 40 with the end cap 50 contacting the top surface of the grating panel 100 (potentially contacting more than the two adjacent grating elements 102), the two adjacent grating elements 102 have been secured to the tool 10. Specifically, the two adjacent grating elements 102 are essentially “captured” on four sides, namely by (1) the elongate shaft 12 along the inner sides (2) the lateral arms 32, 34 of the double hook 30 along the bottom, (3) the upturned legs 36, 38 of the double hook 30 along the outer sides, and (4) the end cap 50 over the top. With the tool 10 secured to the grating panel 100 in this manner, the grating panel 100 can be manipulated using only the tool 10. In other words, the tool 10 can be lifted, rotated, tilted, or carried in order to lift, rotate, tilt or carry the grating panel 100. The tool's grip on the grating panel 100 will not be released until the user manually actuates the trigger 42. Therefore, there is no reason for the user to ever directly touch or grasp the grating panel 100. When a user has completed an intended manipulation of the grating panel, the steps illustrated in FIGS. 3A-E may be performed in reverse to detach the tool 10 from the grating panel 100.

FIGS. 4A-B are cross-section side views of the housing 40 (viewed from line A-A in FIG. 1) disposed about the elongate shaft 12 with a clutch-lock mechanism operatively secured within the housing 40. FIG. 4A illustrates the clutch-lock mechanism in a passive condition gripping the elongate shaft 12, whereas FIG. 4B illustrates the clutch-lock mechanism in a manually actuated condition that releases the grip on the elongate shaft 12. While the entire housing 40 is slidable for translational movement along the elongate shaft 12 when the clutch-lock mechanism is released, there are several components of the clutch-lock mechanism that are pivotally movable or axially moveable independent of any translational movement of the housing 40. In the description that follows, the housing components or features that only move translationally with the housing will be described first for context. Then, the components of the clutch-lock mechanism that move pivotally or axially will be described. It may also be recognized that with the clutch-lock mechanism released (per FIG. 4B) there is nothing preventing the housing 40 from being rotated about the central axis 18 of the elongate shaft 12. However, there is no operational benefit to rotation about the central axis 18 other than, perhaps, to position the trigger 42 on a side of the elongate shaft that is convenient or comfortable for the user during the performance of the steps shown in FIGS. 3A-E.

In reference to FIG. 4A, the housing 40 includes a rigid body 44 that encompasses the elongate shaft 12. The proximal end of the housing 40 secures a front cap 46 that provides a first bearing surface 48 that slidably engages the elongate shaft 12 and provides lateral stability to the proximal end of the rigid body 44. The distal end of the housing 40 secures the end cap 50 that is directed for engagement with an object, such as a grating panel. In the illustrated embodiment, the end cap 50 further secures a sleeve bearing 52 that slidably engages the surface of the elongate shaft 12 and provides lateral stability to the distal end of the rigid body 44. Furthermore, the rigid body 42 includes a central bearing surface 60 that slidably engages the elongate shaft 12 and provides lateral stability to the middle portion of the rigid body 44. The three bearing surfaces 48, 52, 60 allow the housing to slide axially in either the proximal or distal directions, but collectively provide the rigid body 44 with lateral stability.

The rigid body 44 of the housing 40 establishes an open cavity or chamber 62 that provides support for the components of the clutch-lock mechanism that move within the rigid body 44, which include the trigger 42, the cam 70, the locking rings 82 of the locking ring set 80, and the compression spring 90. The open cavity 62 also provides room for these same components of the clutch-lock mechanism to move in accordance with their function. Accordingly, the open cavity 62 may extend around the elongate shaft 12 between the front cap 46 and the central bearing surface 60. The opposing interior walls of the open cavity 62 each further include a groove 64 that is positioned to receive a lower tab of each locking ring 82. The locking rings 82 each encircle the elongate shaft 12. A distal end of the groove 64 may form the distal stop element 66. A portion of the rigid body 44 extends inward into the open cavity 62 to form the proximal stop element 68. Still further, the rigid body 44 has an opening between points 61 and 69 where the trigger 42 is accessible from outside of the rigid body 44 by a user's hand.

The clutch-lock mechanism includes several components that move within the rigid body 44. These components include the trigger 42, the cam 70, the locking rings 82 of the locking ring set 80, and the compression spring 90. In the illustrated embodiment, the trigger 42 is pivotally coupled to the rigid body 44 about a pivot pin 92. The trigger is also shown with a retainer 94 that keeps the trigger 42 in position across the opening between points 61 and 69.

The cam 70 is secured within the rigid body 44 and pivots about a pivot pin 72. A first portion 74 of the cam engages the trigger 42 and a second portion 76 of the cam engages a distal face of the locking ring set 80 on a first side (i.e., the top side as illustrated in FIG. 4A) of the elongate shaft 12. The compression spring 90 engages a proximal face of the locking ring set 80 to bias the locking ring set 80 in a distal direction. However, the distal stop element 66 limits distal movement of the locking ring set 80 on a second side (i.e., the bottom side as illustrated in FIG. 4A) of the elongate shaft 12. Therefore, with the trigger released (i.e., not actuated; not pressed), the compression spring 90 is able to push the first side (top side) of the locking ring set 80 further along the shaft (in the distal direction; to the left as illustrated in FIG. 4A) than the second side (bottom side) of the locking ring set 80. As a result, the locking ring set 80 becomes tilted relative to an axis 18 of the elongate shaft 12 (i.e., the locking ring set is not perpendicular to the elongate shaft) to grip the elongate shaft 12. This is the passive condition of the clutch-lock mechanism because the primary force acting upon the locking ring set 80 is the compression spring 90. A further discussion of the passive condition (locked condition) of the clutch-lock mechanism is provided in reference to FIG. 5A.

FIG. 4B is a cross-sectional side view of the housing 40 (viewed from line A-A in FIG. 1) disposed about the elongate shaft 12 illustrating the clutch-lock mechanism of FIG. 4A in a manually actuated condition that releases the grip on the elongate shaft 12. A user applies a manual force (see arrow 41) to the trigger 42 that causes the trigger 42 to rotate inward about its pivot pin 92. As the trigger 42 rotates inward, the inside surface of the trigger 42 pushes against the first portion 74 of the cam 70 to cause the cam to rotate about its pivot pin 72. The rotation of the cam 70 about the pivot pin 72 (see arrow 71) causes the second portion 76 of the cam 70 to push against the distal face of the locking ring set 80. As shown, the locking ring set 80 includes three locking rings 82 that are in face-to-face engagement, but the locking rings move independently. The second portion 76 of the cam 70 pushes the locking rings 82 from their tilted and gripping position relative to the central axis 18 of the elongate shaft 12 (see FIG. 4A) to overcome the spring force of the compression spring 90 and move to a perpendicular and non-gripping position as shown in FIG. 4B. This movement of the locking rings 82 may be a rotating motion, since the cam 70 pushes against the locking rings 82 on the first (upper) side while the compression spring 90 continues to push against the locking rings on both the first (upper) side and the second (lower) side. In this illustration, the trigger 42 was pressed a sufficient distance to cause the locking rings 82 to be pressed against the proximal stop element 68. As illustrated, the axial distance between the distal stop element 66 and the proximal stop element 68 is substantially equal to the total thickness of the three locking rings 82, such that the three locking rings 82 are substantially perpendicular to the central axis 18 of the elongate shaft 12. In this substantially perpendicular position, the interior cutout of the locking rings 82 is substantially parallel to the surface of the elongate shaft 12 such that the edges of the interior cutout can no longer grip the elongate shaft 12. Accordingly, the housing 40 illustrated in FIG. 4B is in a released condition and is free to be slid along the elongate shaft 12 in either the proximal direction or the distal direction.

FIG. 5 is a diagram of a locking ring 82 having an interior cutout 84 that encircles the elongate shaft 12 (shown in dashed lines). The individual locking ring is representative of each locking ring. The locking ring 82 may be a generally flat steel plate, such that multiple locking rings may be positioned in face-to-face contact to establish a locking ring set, where the locking rings are able to slide against each other. The locking ring 82 has a pair of laterally extending tabs 85 disposed on the second (lower) side of the elongate shaft 12 that fit into corresponding grooves or channels 64 formed on opposing sides (left and right) of the rigid body 44. The locking ring 82 also has a cam follower tab 86 disposed on the first (upper) side of the elongate shaft 12 for contact with the second portion of the cam and the proximal stop element (see FIG. 4B).

The interior cutout 84 of the locking ring 82 has sharp edges that are finely squared-off corners of the interior cutout. It is these sharp edges of the interior cutout that grip the elongate shaft 12. However, the diameter of the interior cutout 84 in the locking ring 82 is slightly larger than the diameter of the elongate shaft 12. Accordingly, the interior cutout 84 is large enough to disengage or release its grip on the elongate shaft 12 when the locking ring 82 is substantially perpendicular to the central axis 18 of the elongate shaft 12 as shown in FIG. 5. However, the diameter of the interior cutout 84 is only slightly larger than the diameter of the elongate shaft 12, such that locking ring 82 requires only a small amount of tilt (angle away from perpendicular to the central axis 18) before the locking ring 82 engages and grips the elongate shaft 12.

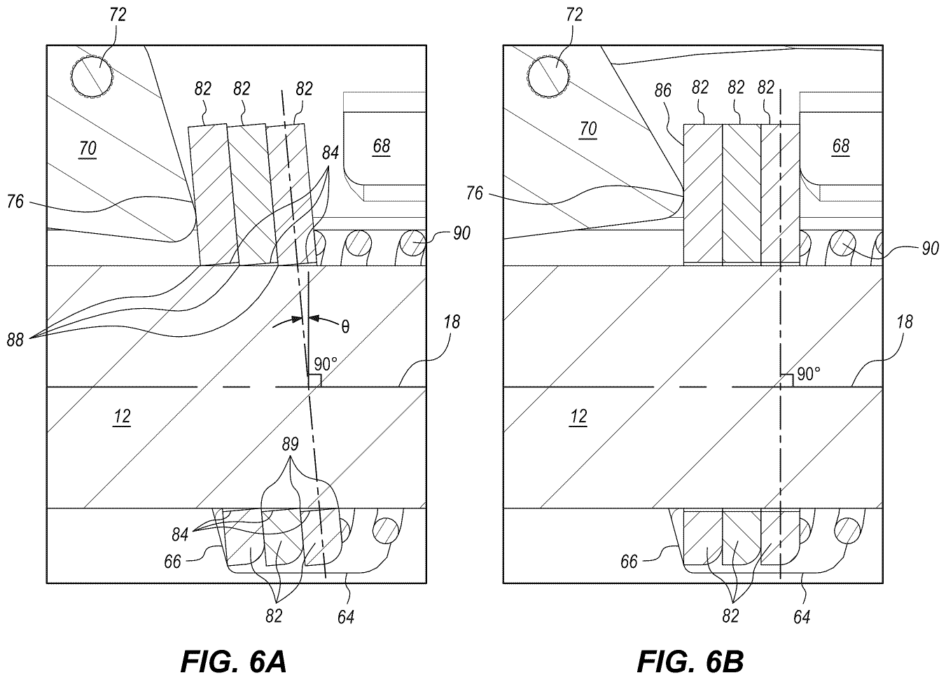

FIGS. 6A-B are diagrams of the locking rings 82 of FIGS. 4A-B that have been enlarged to better illustrate the sharp edges of the interior cutout 84 gripping the elongate shaft 12 (FIG. 6A) and releasing the elongate shaft 12 (FIG. 6B). For each locking ring 82, the interior cutout 84 forms a right angle with the front and back planes or faces of the locking ring 82. In FIG. 6A (corresponding to FIG. 4A), the locking rings 82 are tilted at an angle θ, such that the sharp edges 88 press against the side of the elongate shaft 12 and form a tight grip that resists axial movement of the housing along the elongate shaft 12. Optionally, the locking rings 82 may further use sharp edges 89 to press against the side of the elongate shaft 12. In FIG. 6B (corresponding to FIG. 4B), the second portion 76 of the cam 70 has pushed against the cam follower tab 86 (see also FIG. 5) to press the first (upper) side of the locking rings 82 against the proximal stop element 68, such that the sharp edges 88, 89 are no longer directed into or pressed against the side of the elongate shaft 12. In this position, the locking rings 82 have released their previous tight grip on the elongate shaft 12 and the housing is free to slide axially along the elongate shaft 12.

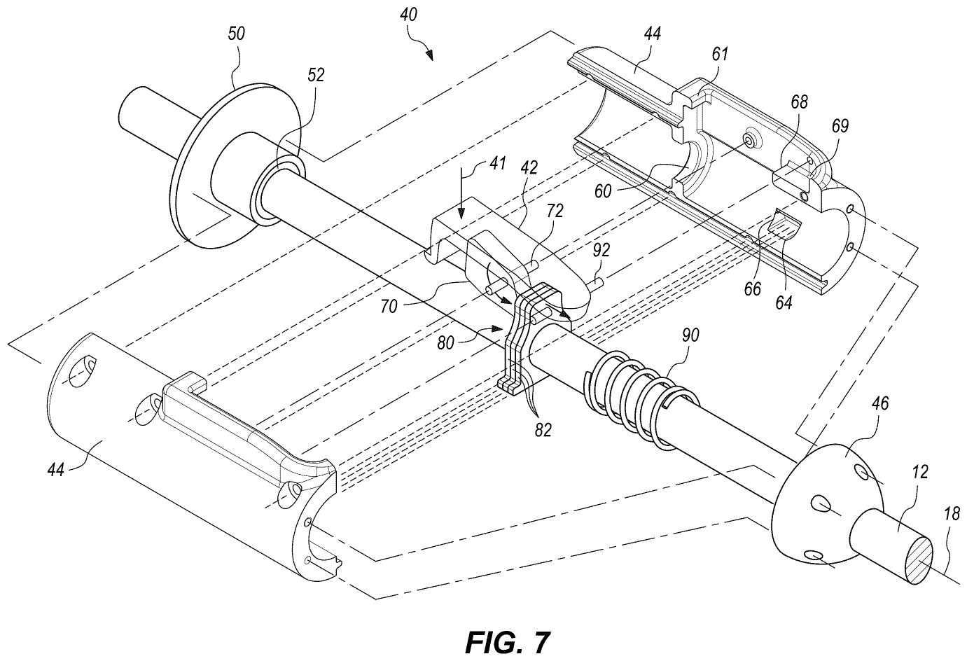

FIG. 7 is an exploded assembly view of the housing 40 and the clutch-lock mechanism in reference to the elongate shaft 12. In this embodiment, the housing 40 may be formed by two housing halves or sides that are secured together around the elongate shaft 12 and hold the components of the clutch-lock mechanism in place. The housing halves may be secured together with screws or bolts. Three bolts are shown along the top edge of the housing halves and another three bolts may be used along the lower edge of the housing halves. Furthermore, the housing may include the end cap 50 at the distal end of the housing and the front cap 46 at the proximal end of the housing. Optionally, the end cap 50 and the front cap 46 may fully encircle the elongate shaft 12 without being formed by two halves. For example, after securing the two housing halves together, the front cap 46 may be secured to the proximal end of the housing halves with screws or bolts. Either or both of the end cap 50 and front cap 46 may include a sleeve bearing or form a bearing surface.

Note that the compression spring 90 and the locking rings 82 must also be slid onto the elongate shaft 12. The compression spring 90 will reside around the elongate shaft 12 within the open cavity between the front cap 46 and the locking rings 82. The locking rings 82 have laterally extending tabs (see FIG. 5) that align with the grooves 64 (only one shown, but a symmetrical groove is also on the other housing half) and are received into the grooves 64 when the two housing halves are secured together. The cam 70 includes pivot pins 72 that are aligned with holes or bearings in the two housing halves and are received into the holes or bearings when the two housing halves are secured together. Furthermore, the trigger 42 includes pivot pins 92 that are aligned with additional holes or bearings in the two housing halves and are received into the holes or bearings when the two housing halves are secured together. After the two housing halves are secured together as shown in FIG. 7, the clutch-lock mechanism is fully operational.

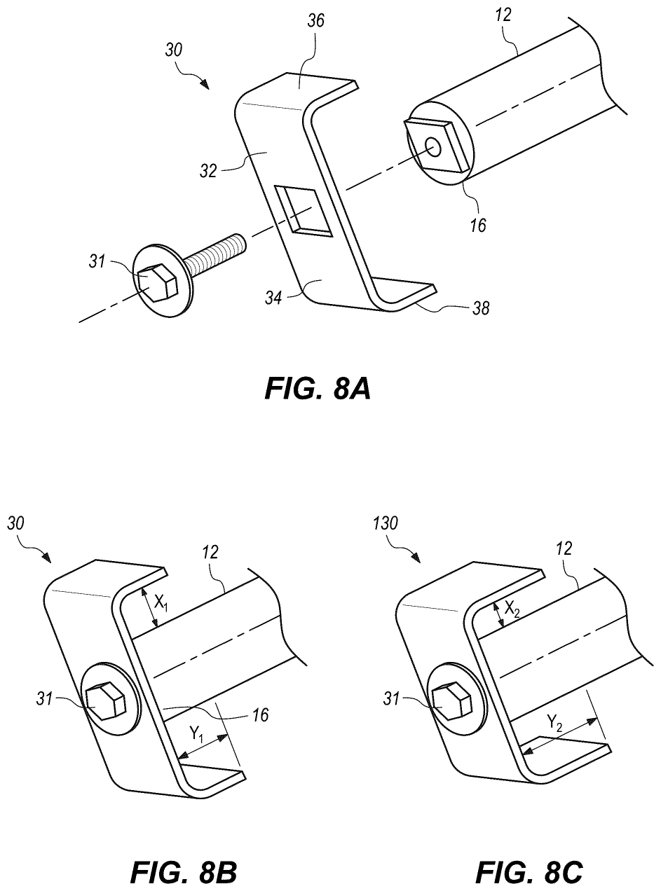

FIG. 8A is a perspective view of a hook 30 aligned to be secured to the distal end 16 of the elongate shaft 12. As in FIG. 1, the hook 30 is a double hook having two lateral arms 32, 34 that extend in opposite directions from the point of connection with the elongate shaft 12 and an upturned end 36, 38 extending from each lateral arm. The hook 30 may have the same or similar width as the diameter of the elongate shaft 12, where the width allows the elongate shaft and hook to fit through the spacing between adjacent bearing bars of a grating panel yet retain enough strength to support the grating panel.

The hook 30 may be detachably secured to the distal end 16 of the elongate shaft 12 using a threaded bolt 31. The detachability of the hook facilitates replacement of a damaged hook and/or substitution of the hook for a hook having a different size, shape or configuration better suited for manipulating a particular object, such as a grating panel. As shown, the distal end 16 of the elongate shaft 12 includes an axial protrusion that is not circular, and the hook may have an opening with a complementary shape that fits around the protrusion and prevents rotation of the hook relative to the elongate shaft. The hook 30 may be secured with the opening positioned around the protrusion using the threaded bolt. Optionally, the threaded bolt may include a flange or may be used in combination with a washer.

FIG. 8B is a perspective view of the hook 30 after being secured to the distal end 16 of the elongate shaft 12 using the bolt 31. The length of the lateral arms 32, 34 is labeled X₁ and the length of the upturned ends 36, 38 is labeled Y₁. The hook should also have a sufficient lateral arm length X₁ to extend under a bearing bar or other grating element. The hook preferably also has an upturned end that extends a length Y₁ that is some fraction of the depth of the bearing bar or other grating element.

FIG. 8C is a perspective view of a second hook 130 secured in the same manner as the hook 30 in FIGS. 8A-B. However, the second hook 130 may be substituted for the hook 30 based upon the grating element dimensions and spacings. The second hook 130 has lateral arms having a length labeled X₂ and upturned ends having a length labeled Y₂. The hook should also have a sufficient lateral arm length X₂ to extend under a bearing bar or other grating element of a second grating panel. The hook preferably also has an upturned end that extends a length Y₂ that is some fraction of the depth of the bearing bar or other grating element of the second grating panel.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A tool, comprising:
an elongate shaft having a proximal end and a distal end;
a handle disposed on the proximal end of the elongate shaft;
a hook secured to the distal end of the elongate shaft;
a housing slidably secured around the elongate shaft between the proximal and distal ends of the shaft; and
a clutch-lock mechanism integrated into the housing and including a manually actuatable trigger, wherein the clutch-lock mechanism passively grips the elongate shaft to prevent the housing from sliding toward the proximal end of the elongate shaft, and wherein manual actuation of the trigger releases the clutch-lock mechanism to allow the housing to slide toward the proximal end of the elongate shaft.

2. The tool of claim 1, wherein the hook and a distal end cap of the housing are configured to secure a grating element of a grating panel therebetween.

3. The tool of claim 2, wherein the hook is a T-shaped double hook having a width that is less than a spacing between two adjacent grating elements of the grating panel, and wherein the double hook has two upturned ends spaced apart by a distance sufficient to extend around opposing sides of the two adjacent grating elements.

4. The tool of claim 2, wherein the grating element is secured with the elongate shaft extending along a first side of the grating element, the hook extending under the grating element and along a second side of the grating element, and the distal end cap of the housing positioned against a top of the grating element.

5. The tool of claim 4, wherein the grating element remains secured between the distal end cap, the elongate shaft and the hook until the trigger is manually actuated to release the clutch-lock mechanism and the housing is slid toward the proximal end of the elongate shaft.

6. The tool of claim 1, wherein the clutch-lock mechanism includes a cam that is pivotally secured within the housing, a locking ring set secured around the elongate shaft and a compression spring, wherein a first portion of the cam engages the trigger and a second portion of the cam engages a distal face of the locking ring set on a first side of the elongate shaft, wherein the compression spring engages a proximal face of the locking ring set to bias the locking ring set in a distal direction, and wherein the housing forms a distal stop element that limits distal movement of the locking ring set on a second side of the elongate shaft.

7. The tool of claim 6, wherein the housing forms a proximal stop element that limits proximal movement of the locking ring set on the first side of the elongate shaft, and wherein the locking ring set is substantially perpendicular to an axis of the elongate shaft when the distal face of the locking ring set is in contact with the distal stop element on the second side of the elongate shaft and the proximal face of the locking ring set is in contact with the proximal stop element on the first side of the elongate shaft.

8. The tool of claim 7, wherein manual actuation of the trigger rotates the cam to cause the second portion of the cam to push against the distal face of the locking ring set on the first side of the elongate shaft to release the locking ring set from gripping the elongate shaft.

9. The tool of claim 6, wherein manual actuation of the trigger rotates the cam to cause the second portion of the cam to push the first side of the locking ring set in the proximal direction against the proximal stop to release the locking ring set from gripping the elongate shaft.

10. The tool of claim 6, wherein the locking ring set includes a plurality of rings, each of the rings having an inner surface with sharp edges.

11. The tool of claim 9, wherein each of the rings in the locking ring set have a pair of outward extending tabs, wherein the housing includes a pair of grooves, and wherein each groove receives one of the tabs to limit movement of the tab.

12. The tool of claim 9, wherein the one or more rings are made with a first material having a hardness that is greater than the hardness of a second material used to make the elongate shaft.

13. The tool of claim 12, wherein the first material is A36 mild steel, and the second material is 1045 carbon steel.

14. The tool of claim 1, wherein the housing has a distal end securing an end cap, wherein the housing is made with plastic and the end cap is made with metal.

15. The tool of claim 14, wherein the distal end cap forms a ring around the elongate shaft.

16. The tool of claim 1, wherein the handle is a D-handle.

17. The tool of claim 1, wherein the hook is detachably secured to the distal end of the elongate shaft with a threaded screw.

18. The tool of claim 17, wherein the distal end of the elongate shaft has an axial protrusion with at least one flat lateral side, wherein the hook has an opening with a shape that fits around the protrusion and prevents rotation of the hook relative to the elongate shaft, and wherein the hook is secured with the opening positioned around the protrusion using a threaded fastener.

19. The tool of claim 1, wherein the housing is formed with two housing halves secured together around the elongate shaft, and wherein the housing secures the components of the clutch-lock mechanism in place.

20. A kit, comprising:
the tool of claim 1; and
one or more additional hooks, wherein each of the additional hooks has a unique size, shape or configuration.
